(19) United States
(12) Patent Application Publication
(10) Pub. No.: US 2020/0095448 A1
(43) Pub. Date: Mar. 26, 2020

(54) Coating Composition Providing Increased Adhesion and/or UV Durability to a Substrate

(71) Applicant: PPG Industries Ohio, Inc., Cleveland, OH (US)

(72) Inventors: Brian E. Woodworth, Glenshaw, PA (US); Anthony M. Chasser, Greensburg, PA (US); Susan F. Donaldson, Allison Park, PA (US); Meredith L. Muskovich, Pittsburgh, PA (US); John C. Reising, Oberlin, OH (US); John R. Schneider, Allison Park, PA (US)

(73) Assignee: PPG Industries Ohio, Inc., Cleveland, OH (US)

(21) Appl. No.: 16/138,152

(22) Filed: Sep. 21, 2018

(51) Int. Cl. C09D 127/16; C09D 7/61; C09D 7/63

(52) U.S. Cl. CPC C09D 127/16; C08L 33/10; C09D 7/63; C09D 7/61

(57) ABSTRACT

A coating composition including a fluoropolymer and a phosphatized acrylic polymer is disclosed, as well as a substrate at least partially coated with the coating composition. A coating composition including a fluoropolymer, an acrylic polymer, and an adhesion promoter including: an anionic clay, a cationic clay, a chelating agent, a zinc-containing compound, a magnesium-containing compound, a manganese-containing compound, or some combination thereof is also disclosed, as well as a substrate at least partially coated with the coating composition.

### FIELD OF THE INVENTION

The present invention relates to a coating composition and a substrate at least partially coated with a coating composition exhibiting improved adhesion and/or UV durability.

### BACKGROUND OF THE INVENTION

Substrates coated with coating compositions may be exposed to harsh outdoor conditions, such as those experienced by substrates exposed to sea coast weather environments. Prolonged exposure to the harsh conditions can lead to degradation of the cured coating. For example, the cured coating may blister and filiform, leading to coating failure because of the harsh conditions. A coating better able to withstand harsh environmental conditions is, therefore, desirable.

### SUMMARY OF THE INVENTION

The present invention is directed to a coating composition including a fluoropolymer and a phosphatized acrylic polymer.

The present invention is also directed to a coating composition including: a fluoropolymer, an acrylic polymer, and an adhesion promoter including: an anionic clay, a cationic clay, a chelating agent, a zinc-containing compound, a magnesium-containing compound, a manganese-containing compound, or some combination thereof.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” acrylic polymer, “a” fluoropolymer, and the like refer to one or more of these items. Also, as used herein, the term “polymer” refers to prepolymers, oligomers, and both homopolymers and copolymers. The term “resin” is used interchangeably with “polymer.”

As used herein, the transitional term “comprising” (and other comparable terms, e.g., “containing” and “including”) is “open-ended” and open to inclusion of unspecified matter. Although described herein as “comprising”, the terms “consisting essentially of” and “consisting of” are also within the scope of the invention.

The present invention is directed to a coating composition including a fluoropolymer and a phosphatized acrylic polymer. The present invention is directed to a coating composition including a fluoropolymer, an acrylic polymer, and an adhesion promoter.

As used herein, the term “fluoropolymer” refers to a polymer prepared from a monomer comprising fluorine. Examples include but are not limited to perfluoroalkoxy tetrafluoroethylene copolymer (PFA), ethylenechlorotrifluoroethylene (E-CTFE), ethylenetetrafluoroethylene (E-TFE), poly(vinylidene fluoride) (PVDF), poly(tetrafluoroethylene), poly(vinyl fluoride), poly(trifluoroethylene), poly(chlorotrifluoroethylene) (CTFE), poly(hexafluoropropylene), and/or mixtures thereof. Mixtures of two or more suitable fluoropolymers may be used, as can copolymers, terpolymers and the like of suitable fluoropolymers. The amount of fluoropolymer in the coating composition may range from 30 to 70 weight percent of the coating composition based on total solids, such as 35 to 65 weight percent. The amount of fluoropolymer in the coating composition may comprise up to 70 weight percent of the coating composition based on total solids, such as up to 65 weight percent, up to 60 weight percent, up to 55 weight percent, up to 50 weight percent, up to 45 weight percent, or up to 40 weight percent. The amount of fluoropolymer in the coating composition may comprise at least 30 weight percent of the coating composition based on total solids, such as at least 35 weight percent, at least 40 weight percent, at least 45 weight percent, at least 50 weight percent, at least 55 weight percent, or at least 60 weight percent.

The acrylic polymer may include a dispersible polymer compatible with the fluoropolymer. As used herein, “compatible” means that the fluoropolymer is able to disperse in the dispersible polymer without falling out of solution or gelling the entire solution. The acrylic polymer may be water dispersible or solvent dispersible. Suitable acrylic monomers for forming the acrylic polymer include one or more of t-butylamino methyl (meth)acrylate, (meth)acrylic acid, methyl (meth)acrylate, ethyl (meth)acrylate, butyl (meth)acrylate, hydroxyethyl (meth)acrylate, hydroxybutyl (meth)acrylate, hydroxypropyl (meth)acrylate and mixtures thereof. It will be appreciated that “(meth)acrylate” and like terms refers to both methacrylate and acrylate, as is conventional in the art.

In certain embodiments, the polymer includes a water dispersible acrylic polymer having acid functionality. As used herein, the term “water dispersible” means that the polymer is a polymer or oligomer that is solubilized, partially solubilized and/or dispersed in some quantity of water with or without additional water soluble solvents. In certain embodiments, the solution is substantially 100 percent water (at least 99 percent water). In other embodiments, the solution may be 50 percent water and 50 percent co-solvent, 60 percent water and 40 percent co-solvent, 70 percent water and 30 percent co-solvent, 80 percent water and 20 percent co-solvent, or 90 percent water and 10 percent co-solvent. Suitable co-solvents include, for example, glycol ethers, glycol ether-esters, alcohols, ether alcohols, N-methyl pyrrolidone, phthalate plasticizers and/or mixtures thereof. In certain applications, it may be desirable to limit the amount of co-solvent.

The acrylic polymer may be solvent dispersible. As used herein, the term “solvent dispersible” means that the polymer is a polymer or oligomer that is solubilized in a solvent other than water. Suitable solvents include, but are not limited to, aliphatic hydrocarbons, aromatic hydrocarbons, ketones, esters, glycols, ethers, ether esters, glycol ethers, glycol ether esters, alcohols, ether alcohols, phthalate plasticizers, N-methyl pyrrolidone and/or suitable mixtures thereof. Phthalate plasticizers include phthalates esters such as diethylhexyl phthalate, diisononyl phthalate, diisodecyl phthalate, dioctyl phthalate, and butyl benzyl phthalate.

The acrylic polymer may include a phosphatized acrylic polymer. The phosphatized acrylic polymer may be prepared from a reaction mixture including a phosphatized acrylic monomer. As used herein, the term “phosphatized acrylic monomer” refers to a monomer including a functional group suitable for forming an acrylic polymer and including a phosphate group. Non-limiting examples of phosphatized acrylic monomers include: phosphate esters of polypropylene glycol mono(meth)acrylate phosphatized acrylic monomers available under the tradename SIPOMER (from Solvay S.A. (Belgium, Brussels)), such as SIPOMER PAM 100, 200, 300, 4000, 5000; phosphatized acrylic monomers available from Polysciences, Inc. (Warrington, Pa.); and Monoacryloxyethyl phosphate Cas #32120-16-4 (available from Alfa Chemistry (Ronkonkoma, N.Y.)). The phosphatized acrylic monomer may have a polymerizable group attached to an extender attached to the phosphate group. The reactive group may comprise methacrylate, acrylate, allyl ether, and/or some combination thereof. The extender may be hydrophilic or hydrophobic.

Suitable non-phosphatized acrylic monomers for forming the acrylic polymer include any monomer suitable for forming the acrylic polymer not including a phosphate group, such as one or more of t-butylamino methyl (meth)acrylate, (meth)acrylic acid, methyl (meth)acrylate, ethyl (meth)acrylate, butyl (meth)acrylate, hydroxyethyl (meth)acrylate, hydroxybutyl (meth)acrylate, hydroxypropyl (meth)acrylate and mixtures thereof.

The acrylic polymer may be prepared from a reaction mixture of a plurality of acrylic monomers described above. For example, the acrylic polymer may be prepared from a reaction mixture including at least one phosphatized acrylic monomer and at least one non-phosphatized acrylic monomer.

The phosphatized acrylic monomer may be present in an amount of at least 0.5 weight percent in the reaction mixture based on the weight of acrylic monomers included in the reaction mixture (e.g., phosphatized acrylic monomers and non-phosphatized acrylic monomers), such as at least 1 weight percent, at least 3 weight percent or at least 5 weight percent. The phosphatized acrylic monomer may be present in an amount of at least 0.2 weight percent in the coating composition based on the total solids of the coating composition, such as at least 0.5 weight percent or at least 1.0 weight percent.

The acrylic polymer, such as the phosphatized acrylic polymer, may have a weight average molecular weight (Mw) of less than 30,000, such as less than 27,000, less than 25,000, less than 22,000, less than 20,000, less than 17,000, or less than 15,000. The Mw of the acrylic polymer, such as the phosphatized acrylic polymer, may range from 10,000-30,000, such as from 10,000-25,000, from 10,000-20,000, from 15,000-30,000, from 15,000-25,000, or from 15,000-20,000. As used herein, Mw and number average molecular weight (Mn) are measured by gel permeation chromatography using a polystyrene standard according to ASTM D6579-11 (gel permeation chromatography used to characterize the polymer samples, was performed using a Waters 2695 separation module with a Waters 2414 differential refractometer (RI detector); tetrahydrofuran (THF) was used as the eluent at a flow rate of 1 ml/min, and two PLgel Mixed-C (300×7.5 mm) columns were used for separation; Mw and Mn of polymeric samples can be measured by gel permeation chromatography relative to linear polystyrene standards of 800 to 900,000 Da).

The fluoropolymer may be a thermoplastic polymer. By “thermoplastic polymer” it is meant to include polymers that undergo liquid flow upon heating and/or can be soluble in certain solvents. A thermoplastic polymer can be heated to become pliable or moldable and re-solidify upon cooling.

The acrylic polymer may be a thermoplastic polymer. However, in other examples, the acrylic polymer may be a thermoset polymer. By “thermoset polymer” it is meant a polymer having functional groups that are reactive with themselves and/or a crosslinking agent, and upon such reaction (referred to as curing), the polymer forms irreversible covalent bonds (“sets”). Once cured or crosslinked, a thermoset polymer will not melt upon the application of heat and is insoluble in solvents.

The coating composition may include a thermoplastic fluoropolymer and a thermoplastic acrylic polymer (such as a thermoplastic phosphatized acrylic polymer), such that the resulting coating composition is a thermoplastic coating composition. The coating composition may include a thermoplastic fluoropolymer and a thermoset acrylic polymer (such as a thermoset phosphatized acrylic polymer), such that the resulting coating composition, when further including a crosslinker, possesses characteristics of a thermoset coating composition and a thermoplastic coating composition, such that the coating composition has some degree of chemical crosslinking. In this way, the resulting coating composition may have characteristics of both a thermoplastic and a thermoset, such as the flexibility and corrosion resistance of a thermoplastic, and an enhanced strength of a thermoset.

The coating composition may further include an additional dispersible polymer(s) compatible with the fluoropolymer. Non-limiting examples of additional dispersible polymers may include poly(vinyl acetate), poly(vinyl methyl ketone), polybutadiene, poly(urethane), and combinations thereof.

The coating composition may further include a blocked isocyanate. In certain coating compositions, the blocked isocyanate does not react as a crosslinker. By not reacting in the coating composition in a manner to function as a crosslinker, it is meant that the blocked isocyanate may react in the coating composition, but it does not react with functional groups of the fluoropolymer, the acrylic polymer, or other additional dispersible polymers. The blocked isocyanate may instead react with functional groups on the substrate to which the coating composition is applied, residual moisture in the coating composition, or itself, but does not react with the fluoropolymer, the acrylic polymer, or other additional dispersible polymers of the coating composition to crosslink the coating composition.

The blocked isocyanate included in the coating composition, but not necessarily functioning as a crosslinker, may be included in the coating composition in an amount up to 20 weight percent based on the total solids of the coating composition, such as up to 15 weight percent, up to 10 weight percent, or up to 5 weight percent. Non-limiting examples of such a blocked isocyanate include: those blocked isocyanates available under the tradename VESTAGON, available from Evonik Industries (Essen, Germany), blocked isocyanates available from Covestro AG (Leverkusen, Germany) under the tradename CRELAN, and TRIXINE blocked isocyanates available from Baxenden Chemicals (Baxenden, United Kingdom)) (e.g., BI-7641, BI-7642, BI-7986, BI-7987, BI-7950, BI-7951, BI-7960, BI-7961, BI-7963, BI-7981, BI-7982, BI-7984, BI-7990, BI-7991, BI-7992).

The blocked isocyanate may include an organic blocked isocyanate. Unless otherwise indicated herein, the term “organic blocked isocyanate” refers to a blocked isocyanate compound that is free of silicon atoms, i.e., a silane-free blocked isocyanate. Suitable organic blocked isocyanates used in the coating compositions have at least one blocked isocyanate group. The organic blocked isocyanates may be polyisocyanates, i.e., compounds having more than one isocyanate functional group such as diisocyanates, triisocyanates, etc. Non-limiting examples of suitable organic blocked isocyanates include blocked polyisocyanates based on a hexamethylene diisocyanate (HDI); isophorone diisocyanate (IPDI); blocked cyclohexylene diisocyanates, such as 1,4-cyclohexylene diisocyanates; blocked dicyclohexylmethane diisocyanates, such as 4,4′-diisocyanato-dicyclohexylmethanes; xylylene diisocyanates (XDI); tetramethylxylene diisocyanates (TMXDI); toluene diisocyanates (TDI); naphthalene diisocyanates (NDI); phenylene diisocyanates; toluidine diisocyanates (TODI); diphenylmethane diisocyanates (MDI); any diisocyanates derived from the foregoing, triisocyanates, and combinations thereof. Blocked polyisocyanates based on HDI and IPDI are considered blocked aliphatic polyisocyanates, and may be included when organic blocked isocyanates are used in the coating composition. Commercial examples of organic blocked isocyanates based on HDI include DESMODUR BL 3175A, DESMODUR BL 3370, TRIXENE BI 7960, TRIXENE BI 7961, TRIXENE BI 7982, and TRIXENE BI 7984 (where the DESMODUR products are available from Bayer MaterialScience (Leverkusen, Germany) and the TRIXENE products are available from Baxenden Chemicals (Baxenden, United Kingdom)). Commercial examples of organic blocked isocyanates based on IPDI include DESMODUR BL 3370 (of Bayer Material Science) and TRIXENE BI 7950 (of Baxenden Chemicals). Suitable blocking agents used to block the organic blocked isocyanates include active methyl-type, lactam-type, alcohol-type, oxime-type, and phenolic-type blocking agents. Non-limiting examples of blocking agents include dimethylpyrazole (DMP), i.e., 3,5-dimethylpyrazole; methylethylcetoxime (MEKO); diethyl malonate (DEM); and the like.

The coating composition may further include an adhesion promoter. The adhesion promoter may include: a clay (e.g., an anionic clay, a cationic clay), a chelating agent, a zinc-containing compound, a magnesium-containing compound, a manganese-containing compound, or some combination thereof.

As used herein, the term “chelating agent” refers to a polydentate ligand that forms two or more separate coordinate bonds with a single central atom. As used herein, the term “anionic clay” may refer to a material containing positively charged layers with anions in the interlayers. As used herein, the term “cationic clay” may refer to a material containing negatively charged layers with cations in the interlayers. The anionic clay may include a hydrotalcite or a hydrotalcite-like compound. As used herein, the term “hydrotalcite” refers to a natural mineral of formula Mg₆Al₂CO₃(OH)₁₆.4(H₂O), which is a member of the layered double hydroxide family of anionic clays. As used herein, the term “hydrotalcite-like compound” refers to a layered double hydroxide having variations on the structure of hydrotalcite, such as variations regarding Mg/Al ratio or the choice of divalent metal and/or interlayer anion. Hydrotalcite-like compounds may include anionic clays layered with water and carbonate ions. The water may be hydrogen bonded with the carbonate ions (hydrogens on a water molecule hydrogen bond with carbonate ions and oxygens on the other water molecules), and the carbonate molecules may be weakly bound leading to anionic exchange properties. As previously mentioned, the adhesion promoter may include cationic clays. The cationic clays may include a smectite group. As previously mentioned, the adhesion promoter may include a zinc-containing compound, such as zinc acetylacetonate hydrate (ZnAcAc), zinc flakes, and zinc phosphate.

Non-limiting examples of suitable adhesion promoters as anionic or cationic clays are shown in Table 1 below.

TABLE 1

| Mineral name | Chemical Name | Chemical Formula |
|---|---|---|
| Huntite | — | Mg₃Ca(CO₃)₄ |
| Hydromagnesite | magnesium carbonate | Mg⁴(CO₃)₄•Mg(OH)₂•4(H₂O) |
| | hydroxide tetrahydrate | |
| Artinite | magnesium carbonate | MgCO₃•Mg(OH)₂•3(H₂O) |
| | hydroxide hydrate | |
| Dypingite | magnesium carbonate | Mg₄(CO₃)₄•Mg(OH)₂•5(H₂O) |
| | hydroxide pentahydrate | |
| nesquehonite | — | MgCO₃•3(H₂O) |
| Magnesium | Magnesium Carbonate | MgCO₃•n(H2O) |
| Carbonate Hydrate | Hydrate | |
| Magnesium | Magnesium Carbonate | MgCO₃ |
| Carbonate | | |
| Manganese | Manganese Carbonate | MnCO₃ |
| Carbonate | | |
| Manganese | Manganese Carbonate | MnCO₃•n(H₂O)n |
| Carbonate hydrate | hydrate | |
| Hydrotalcite | — | Mg₆Al₂CO₃(OH)₁₆•4(H₂O) |
| Montmorillonite | — | (Na,Ca)_{0.33}(Al,Mg)₂(Si₄O₁₀)(OH)₂•n(H₂O) |
| Serpentine | — | Mg₃(Si₂O₅)(OH)₄ |
| Chrysotile (asbestos) | | |
| Barringtonite | — | MgCO₃•2(H₂O) |
| Nesquehonite | — | MgCO₃•3(H₂O) |
| Lansfordite | — | MgCO₃•5(H₂O) |
| Artinite | — | MgCO₃•Mg(OH)₂•3(H₂O) |
| Hydromagnesite | — | Mg4(CO₃)₄•Mg(OH)₂•4(H₂O) |
| Dypingite | — | Mg4(CO₃)₄•Mg(OH)₂•5(H₂O) |
| Brugnatellite | — | Mg₆Fe³⁺(CO₃)(OH)₁₃•4H₂O |
| Coalingite | — | Mg₁₀Fe³⁺₂(OH)₂₄[CO₃]•2H₂O |
| Cualstibite | — | Cu₂Al(OH)₆[Sb⁵⁺(OH)₆] |
| Omsite | — | Ni₂Fe³⁺(OH)₆[Sb(OH)₆] |
| Zincalstibite | — | Zn₂Al(OH)₆[Sb⁵⁺(OH)₆] |
| Fougèrite Group | — | |
| Fougèrite | — | Fe²⁺₄Fe³⁺₂(OH)₁₂[CO₃]•3H₂O |
| Mössbauerite | — | Fe³⁺₆O₄(OH)₈[CO₃]•3H₂O |
| Trébeurdenite | — | Fe²⁺₂Fe³⁺₄O₂(OH)₁₀CO₃•3H₂O |
| Glaucocerinite | — | |
| Group | | |
| Carrboydite | — | [(Ni₁₋ₓAlₓ)(OH)₂][SO₄]_{x/2}•nH₂O |
| Glaucocerinite | — | (Zn₁₋ₓAlₓ)(OH)₂(SO₄)_{x/2}•nH₂O |
| Hydrohonessite | — | (Ni₁₋ₓFe³⁺ₓ)(OH)₂[SO₄]_{x/2}•nH₂O |
| Mountkeithite | — | [(Mg₁₋ₓFe³⁺ₓ)(OH)₂][SO₄]_{x/2}•nH₂O |
| Zincaluminite | — | Zn₆Al₆(SO₄)₂(OH)₁₆•5H₂O |
| Hydrocalumite | — | |
| Group | | |
| Hydrocalumite | — | Ca₄Al₂(OH)₁₂(Cl,CO₃,OH)₂•4H₂O |
| Kuzelite | — | Ca₄Al₂(OH)₁₂[SO₄]•6H₂O |
| Hydrotalcite | — | Mg₆R³⁺₂(OH)₁₆CO₃•4H₂O, |
| Group | | where R³⁺ = Al, Cr, or Fe |
| Desautelsite | — | Mg₆Mn³⁺₂(OH)₁₆[CO₃]•4H₂O |
| Droninoite | — | Ni₆Fe²⁺₃(OH)₁₆Cl₂•4H₂O |
| Hydrotalcite | — | Mg₆Al₂(OH)₁₆[CO₃]•4H₂O |
| UM1965-08- | — | Fe—Mg—Ni—O—H |
| OH:FeMgNi | | |
| Iowaite | — | Mg₆Fe³⁺₂(OH)₁₆Cl₂•4H₂O |
| Meixnerite | — | Mg₆Al₂(OH)₁₆(OH)₂•4H₂O |
| Pyroaurite | — | Mg₆Fe³⁺₂(OH)₁₆[CO₃]•4H₂O |
| Reevesite | — | Ni₆Fe³⁺₂(OH)₁₆(CO₃)•4H₂O |
| Stichtite | — | Mg₆Cr³⁺₂(OH)₁₆[CO₃]•4H₂O |
| Takovite | — | Ni₆Al₂(OH)₁₆[CO₃]•4H₂O |
| Woodallite | — | Mg₆Cr₂(OH)₁₆Cl₂•4H₂O |
| Muskoxite | — | Mg₇Fe₄O₁₃•10H₂O |
| Quintinite Group | — | |
| Caresite | — | Fe²⁺₄Al₂(OH)₁₂[CO₃]•3H₂O |
| Charmarite | — | Mn²⁺₄Al₂(OH)₁₂[CO₃]•3H₂O |
| Chlormagaluminite | — | Mg₄Al₂(OH)₁₂Cl₂•3H₂O |
| Comblainite | — | Ni₄Co₂(OH)₁₂[CO₃]•3H₂O |
| Quintinite | — | Mg₄Al₂(OH)₁₂[CO₃]•3H₂O |
| Zaccagnaite | — | Zn₄Al₂(OH)₁₂[CO₃]•3H₂O |
| UM1987-05- | — | Mg₄Al₂(OH)₁₂(CO₃,SO₄)•3H₂O |
| OH:AlCMg | | |
| Wermlandite | — | |
| Group | | |
| Karchevskyite | — | Mg₁₈Al₉(OH)₅₄Sr₂(CO₃)₉(H₂O)₆(H₃O)₅ |
| Motukoreaite | — | Mg₆Al₃(OH)₁₈[Na(H₂O)₆][SO₄]₂•6H₂O |
| Natroglaucocerinite | — | Zn₆Al₃(OH)₁₈[Na(H₂O)₆](SO₄)₂•6H₂O |
| Nikischerite | — | Fe²⁺₆Al₃(OH)₁₈[Na(H₂O)₆][SO₄]₂•6H₂O |
| Shigaite | — | Mn₆Al₃(OH)₁₈[Na(H₂O)₆][SO₄]₂•6H₂O |
| Wermlandite | — | Mg₇Al₂(OH)₁₈[Ca(H₂O)₆][SO₄]₂•6H₂O |
| Woodwardite | — | |
| Group | | |
| Honessite | — | (Ni₁₋ₓFe³⁺ₓ)(OH)₂[SO₄]_{x/2}•nH₂O |
| Woodwardite | — | Cu₁₋ₓAlₓ(OH)₂[SO₄]_{x/2}•nH₂O |
| Zincowoodwardite | — | Zn₁₋ₓAlₓ(OH)₂[SO₄]_{x/2}•nH₂O |
| Aliettite | — | Ca_{0.2}Mg₆((Si,Al)₈O₂₀)(OH)₄•4H₂O |
| Beidellite | — | (Na,Ca_{0.5})_{0.3}Al₂((Si,Al)₄O₁₀)(OH)₂•nH₂O |
| Calcium | — | |
| montmorillonite | | |
| Ferrosaponite | — | Ca_{0.3}(Fe²⁺,Mg,Fe³⁺)₃((Si,Al)₄O₁₀)(OH)₂•4H₂O |
| Hectorite | — | Na_{0.3}(Mg,Li)₃(Si₄O₁₀)(F,OH)₂ |
| Montmorillonite | — | (Na,Ca)_{0.33}(Al,Mg)₂(Si₄O₁₀)(OH)₂•nH₂O |
| Nontronite | — | Na_{0.3}Fe₂((Si,Al)₄O₁₀)(OH)₂•nH₂O |
| Pimelite | — | Ni₃Si₄O₁₀(OH)₂•4H₂O |
| Saliotite | — | (Li,Na)Al₃(AlSi₃O₁₀)(OH)₅ |
| Saponite | — | Ca_{0.25}(Mg,Fe)₃((Si,Al)₄O₁₀)(OH)₂•nH₂O |
| Sauconite | — | Na_{0.3}Zn₃((Si,Al)₄O₁₀)(OH)₂•4H₂O |
| Stevensite | — | (Ca,Na)ₓMg₃₋ₓ(Si₄O₁₀)(OH)₂ |
| Swinefordite | — | Li(Al,Li,Mg)₄((Si,Al)₄O₁₀)₂(OH,F)₄•nH₂O |
| Volkonskoite | — | Ca_{0.3}(Cr,Mg,Fe)₂((Si,Al)₄O₁₀)(OH)₂•4H₂O |
| Yakhontovite | — | (Ca,Na)_{0.5}(Cu,Fe,Mg)₂(Si₄O₁₀)(OH)₂•3H₂O |
| Zincsilite | — | Zn₃(Si₄O₁₀)(OH)₂•4H₂O |

Combinations of any of the above-described adhesion promoters may be included in the coating composition.

The adhesion promoter may be included in the coating composition in an amount up to 10 weight percent based on the total solids of the coating composition, such as up to 7 weight percent, up to 5 weight percent, or up to 1 weight percent. The amount of the adhesion promoter included in the coating composition may range from 1-10 weight percent based on the total solids of the coating composition, 1-7 weight percent, 1-5 weight percent, 5-10 weight percent, 5-7 weight percent, or 7-10 weight percent.

The coating composition may further include a crosslinker. The crosslinker may be any crosslinker suitable for reaction with a functional group of the fluoropolymer, the acrylic polymer, or other additional dispersible polymers. The crosslinker may be in solid or liquid form. Non-limiting examples of suitable crosslinkers include hydroxyalkyl amides, such as those commercially available from EMS-Griltech (Domat/Ems, Switzerland) under the tradename PRIMID, glycidyl functional acrylics, triglycidylisocyanurate, carbodiimides, such as those commercially available from ANGUS Chemical Co. (Sterlington, La.) under the tradename UCARLINK, melamines, such as those available from Allnex (Frankfurt, Germany) under the tradename CYMEL, blocked isocyanates, such as those available from Covestro AG (Leverkusen, Germany) under the tradename CRELAN those blocked isocyanates available under the tradename VESTAGON, available from Evonik Industries (Essen, Germany), and TRIXINE blocked isocyanates available from Tri-iso Tryline (Cardiff by the Sea, Calif.) (e.g., BI-7641, BI-7642, BI-7986, BI-7987, BI-7950, BI-7951, BI-7960, BI-7961, BI-7963, BI-7981, BI-7982, BI-7984, BI-7990, BI-7991, BI-7992).

In one non-limiting example, the coating composition may include the fluoropolymer, the phosphatized acrylic polymer, the blocked isocyanate, and the adhesion promoter, as disclosed above, in combination.

The coating composition may be in the form of a powder coating composition. The powder coating composition may be produced by mixing the fluoropolymer with the acrylic polymer. The acrylic polymer may be provided in a dispersion (aqueous) such that the fluoropolymer is mixed in the acrylic polymer dispersion to form a mixture. The blocked isocyanate and/or the adhesion promoter may further be added to the mixture. Mixing may be achieved by any means standard in the art, such as by using a Cowles mixer, a media mill, a rotor-stator mill and the like, until the desired particle size of pigment additions and the fluoropolymer is achieved. The mixture may be mixed until the mixture is substantially homogenous. The mixture may be dried according to any means known in the art, such as by spray drying, tray drying, freeze drying, fluid bed drying, single and double drum drying, flash drying, swirl drying, and numerous other evaporation techniques, the use of all of which will be familiar to those skilled in the art.

The dried mixture may then be ground to a desired particle size to form the powder coating composition. Grinding may be accomplished by any means known in the art, such as through the use of a classifying mill. Median particle size of the powder may be up to 100 microns, such as up to 90 microns, up to 80 microns, up to 70 microns, up to 60 microns, or up to 50 microns. As used herein, median particle size means volume median particle size unless otherwise indicated. The median particle size was determined using laser diffraction analysis unless otherwise indicated. Median particle sizes of 20 to 50 microns may be desired for certain applications, such as 30 to 40 microns.

In other examples, the coating composition may be prepared as a liquid coating composition including the above-described components mixed in a solvent. In this example, the acrylic polymer may be prepared in water and/or DOWANOL PM, DOWANOL PM acetate (or other solvent), and then additional solids may be added to the acrylic polymer and mixed using a Cowles blade.

A powder or liquid pigmented coating composition may be prepared that includes the above-described coating composition. The pigmented coating composition may include blending a first dispersion that includes above-described coating composition and a second dispersion including a pigment. A dispersion blend of the first dispersion and the second dispersion may be dried. The dried dispersion blend may then undergo grinding. The drying and grinding are as previously described. Blending the first dispersion and the second dispersion may be done by any means known in the art, such as mixing with a low shear mixer or by shaking. In certain embodiments, the first and/or the second dispersion may be automatically dispensed from a computerized dispensing system. For example, to the first dispersion may be added to the second dispersion, or a combination of second pigment dispersions, to achieve the desired color. The desired amount and type of the second pigment dispersion(s) to add to the first dispersion may be determined, for example, by use of color matching and/or color generating computer software known in the art.

The second dispersion including a pigment may include the same dispersible polymer (such as one of the above-described acrylic polymers) as the first dispersion, or may include a different dispersible polymer. If different dispersible polymers are used, they should be selected so as to be compatible both with each other, and with the fluoropolymer. Both the first and second dispersions may be water based, or both solvent based, or one of the first dispersion and the second dispersion may be water based while the other may be solvent based. As used herein, the term “water based” refers to a dispersion that includes a water dispersible polymer. As used herein, the term “solvent based” refers to a dispersion that includes a solvent dispersible polymer.

The pigment may be added to the second dispersion in the same manner as the fluoropolymer is added to the acrylic dispersion (described above). The amount of pigment in the second dispersion may be any amount that imparts a desired color, such as from 1 to 50 weight percent, based on the total solids weight of the dispersion.

Any suitable pigments may be included in the pigmented coating composition according to the present invention. As used herein, “pigment” and like terms refer generally to anything that imparts color to a composition; “pigment” and like terms therefore includes all colorants, such as pigments, dyes, and tints, including but not limited to those used in the paint industry and/or listed in the Dry Color Manufacturers Association (DCMA) as well as special effect compositions. A pigment may include, for example, a finely divided solid powder that is insoluble but wettable under the conditions of use. A pigment may be organic or inorganic and can be agglomerated or non-agglomerated.

Suitable pigments that may be used according to the present invention include, but are not limited to, the inorganic metal oxides, organic compounds, metal flake and mica pigments for “metallic” effect colors, extender or filler pigments, and corrosion-inhibitive pigment types, such as chromates, silicas, silicates, phosphates, and molybdates. Examples of organic pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), and/or mixtures thereof. Examples of suitable inorganic pigments include titanium dioxide, carbon black, iron oxides, and/or calcined mixed metal oxides. Extender or filler pigments include kaolin, talc, calcium carbonate, diatomaceous earth, synthetic calcium silicates, perlite, cellulose fibers, ground silica, calcined clays, microspheres, fumed silica, treated fumed silicas, titanium dioxide, wet ground micas, synthetic fibers, snobrite clay, bentonite clay, micronized micas, attapulgite clays, and/or alumina trihydrate. In addition, leafing and non-leafing aluminums and micas may be incorporated with or without other pigments. Any amount of pigment suitable to impart the desired color may be used.

Suitable pigments may include stir-in pigments, such as those commercially available from The Shepherd Color Company (Cincinnati, Ohio).

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896, commercially available from Evonik Industries (Essen, Germany), CHARISMA COLORANTS, commercially available from Accurate Dispersions (South Holland, Ill.), and MAXITONER Industrial Colorants, commercially available from Accurate Dispersions (South Holland, Ill.).

The pigment may be in the form of a dispersion including, but not limited to, a nanoparticle dispersion. Nanoparticle dispersions may include one or more highly dispersed nanoparticle pigment or pigment particles that produce a desired visible color and/or opacity and/or visual effect. Nanoparticle dispersions may include pigments or dyes having a particle size of less than 150 nm, such as less than 70 nm, or less than 30 nm. The nanoparticles may be produced by milling stock organic or inorganic pigments with grinding media having a particle size of less than 0.5 mm Example nanoparticle dispersions and methods for making them are identified in U.S. Pat. No. 6,875,800, col. 3 1. 25-col 5 1. 11 and col. 9, 1. 14-col. 14 1. 53, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of polymer-coated nanoparticles may be used. As used herein, a “dispersion of polymer-coated nanoparticles” refers to a continuous phase in which is dispersed discreet “composite microparticles” that comprise a nanoparticle and a polymer coating on the nanoparticle. Example dispersions of polymer-coated nanoparticles and methods for making them are identified in U.S. Pat. No. 7,438,972, entire reference, which is incorporated herein by reference.

Example special effect compositions that may be used in the pigmented coating composition of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as opacity or texture. In a non-limiting embodiment, special effect compositions may produce a color shift, such that the color of the coating changes when the coating is viewed at different angles. Example color effect compositions are identified in U.S. Pat. No. 6,894,086, entire reference, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

A photosensitive composition and/or photochromic composition, which reversibly alters its color when exposed to one or more light sources, may be used in the pigmented coating composition of the present invention. Photochromic and/or photosensitive compositions may be activated by exposure to radiation of a specified wavelength. When the pigmented coating composition becomes excited, the molecular structure is changed and the altered structure exhibits a new color that is different from the original color of the pigmented coating composition. When the exposure to radiation is removed, the photochromic and/or photosensitive composition may return to a state of rest, in which the original color of the composition returns. In one non-limiting embodiment, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

In a non-limiting embodiment, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. Pat. No. 8,153,344, entire reference, which is incorporated herein by reference.

As described above, either or both of the first and second dispersion may be water-based. Similarly, the dispersing fluid of either or both may be substantially 100 percent water, or can be 50 percent water and 50 percent co-solvent, 60 percent water and 40 percent co-solvent, 70 percent water and 30 percent co-solvent, 80 percent water and 20 percent co-solvent, or 90 percent water and 10 percent co-solvent, as described above.

It may be desired to partially or wholly neutralize any acid functionality on the dispersible polymer (e.g., the above-described acrylic dispersion) of the first dispersion and/or the second dispersion. Neutralization can assist in the preparation of a water based dispersion. Any suitable neutralizing agent may be used, such as triethyl amine, triethanol amine, dimethyl ethanolamine, methyl diethanolamine, diethyl ethanolamine, diisopropyl amine, ammonium hydroxide, and combinations thereof.

A crosslinker may be included in either or both of the first and the second dispersions. Any of the crosslinkers described above may be used.

Determining whether the desired color for the pigmented coating composition was achieved may be performed by producing, for example, a drawdown or spray out of the pigmented coating composition to see if the appropriate color is obtained. If not, more of the first dispersion and/or the second dispersion may be added to adjust the color accordingly. The adjusted pigmented coating composition may then be dried, or it can be further tested to confirm that the desired color is achieved. It will be appreciated that the present methods provide efficient ways to perform color matching, particularly as compared with traditional methods for powder coating preparation.

Any additives standard in the coatings art may be added to the above-described coating composition or the pigmented coating composition. This includes, for example, fillers, extenders, UV absorbers, light stabilizers, plasticizers, surfactants, wetting agents, defoamers, and combinations thereof.

The coating composition may, upon curing, form a clearcoat. A clearcoat will be understood as a coating that is substantially transparent or translucent. A clearcoat may therefore have some degree of color, provided it does not make the clearcoat opaque or otherwise affect, to any significant degree, the ability to see the underlying substrate. The clearcoats of the present invention may be used, for example, in conjunction with a pigmented basecoat. The clearcoat may be formulated as is known in the coatings art.

The coating composition and/or the pigmented coating composition, once prepared, may be applied to at least a portion of a substrate and cured to form a coating. The coating compositions of the present invention may be applied to a substrate in any number of ways, such as by electrostatic spraying. Other standard methods for coating application may also be employed, such as such as electrocoating, dipping, rolling, brushing, and the like. The cured coating may have any desired dry film thickness. For example, the dry film thickness may range from 0.5 to 4 mils (12.7 μm to 101.6 μm), such as 2 to 3 mils (50.8 μm to 76.2 μm).

The coating composition and/or the pigmented coating composition may be applied to a substrate made of any suitable material. For example, the substrate may be metallic or non-metallic and may be subjected to outdoor conditions over long periods of time.

The metallic substrate may include aluminum or chrome treated aluminum. The metallic substrates may include, but is not limited to, tin, steel (including stainless steel, electrogalvanized steel, cold rolled steel, and hot-dipped galvanized steel, among others), aluminum alloys, zinc-aluminum alloys, steel coated with a zinc-aluminum alloy, or aluminum plated steel. The metallic substrates may also further include a metal pretreatment coating, also referred to as a conversion coating. Examples of suitable pretreatment compositions include, but are not limited to, compositions that contain zinc phosphate, iron phosphate, or chromium-containing components. Other examples of suitable pretreatment coatings include, but are not limited to, thin-film pretreatment coatings, which include compositions such as a zirconium or titanium-containing components. The metal pretreatment coating may also include a sealer, such as a chromate or non-chromate sealer. The metallic substrates may also be coated with a primer such as a cationic electro-coat primer.

The substrate may be non-metallic. Non-metallic substrates may include polymeric materials. Suitable polymeric materials for the substrate may include plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, polycarbonate acrylonitrile butadiene styrene (PC/ABS), or polyamide. Other non-metallic substrates may include glass, wood, wood veneer, wood composite, particle board, medium density fiberboard, cement, stone, paper, cardboard, textiles, leather, both synthetic and natural, and the like. Non-metallic substrates may also include a treatment coating that is applied before application of the coating, which increases the adhesion of the coating composition to the substrate.

Metallic substrates may be exposed to harsh environmental conditions, such as those environmental conditions experienced by substrates in seacoast environments. Suitable materials for such metallic substrates include aluminum and steel. The aluminium may be bare or pretreated (crome, chrome-free, etc.) aluminum. The steel substrates may be bare steel or steel that is pretreated (zircobond, phosphate, etc.).

When the coating composition and/or the pigmented coating composition is applied to the substrate and cured to form a coating, the cured coating may exhibit enhanced adhesion to the substrate (compared to coating compositions prepared not including the phosphatized acrylic polymer and/or the adhesion promoter). When the coating composition is applied to the substrate and cured to form a coating, the cured coating may exhibit improved corrosion resistance and/or improved UV durability (compared to coating compositions prepared not including the phosphatized acrylic polymer and/or the adhesion promoter).

The coating composition and/or the pigmented coating composition may be applied to the substrate as the sole coating layer, such that the coating composition is the only coating layer applied to the substrate. As used herein, the term “coating layer” refers to a continuous film formed by application of a coating composition that, once cured, forms the coating layer. The sole coating layer may be applied to the substrate in combination with a treatment. As used herein, the term “treatment” refers to a material applied over the substrate that, once cured, does not form a continuous film thereover, such as the previously-described pretreatments.

The coating composition and/or the pigmented coating composition may be used in combination with one or more other coating compositions, to form a multi-layer coating system having two or more coating layers. For example, the coating composition of the present invention may or may not include a pigment and may be used as a primer, basecoat, and/or top coat. For example, the coating composition may be a clear top coat for application over another thermoplastic or thermoset coating. The coating compositions of the present invention may be applied over a primer layer to provide better adhesion to the substrate, improved corrosion resistance, and/or improved UV durability. The coating composition may be applied as an outermost coating layer of a multi-layer coating system. The coating composition may be directly to the substrate itself, e.g., direct to metal.

### EXAMPLES

The following examples are presented to exhibit the general principles of the invention. The invention should not be considered as limited to the specific examples presented. All parts and percentages in the examples are by weight unless otherwise indicated.

### Example 1

### Preparation of a Phosphatized Acrylic Polymer

A phosphatized acrylic polymer was prepared by mixing the components in the amounts listed in Table 2.

TABLE 2

| Ingredients | Parts by weight |
|---|---|
| DOWANOL PM¹ | 1755.6 |
| LUPEROX 575² | 72.6 |
| Ethyl Acrylate | 261.8 |
| Methyl Methacrylate | 1760.0 |
| PAM 200³ | 68.2 |
| Methacrylic Acid | 110.0 |
| t-Dodecyl Mercaptan | 13.2 |

¹A propylene glycol monomethyl ether, available from Dow Chemical Company Midland, MI)
²A t-amyl peroxy 2-ethyl hexanoate, available from Arkema, Inc. (Colombes, France)
³A phosphate ester of polypropylene glycol monomethacrylate, available from Solvay S.A. (Brussels, Belgium)

The resulting phosphatized acrylic polymer solution thus obtained had a theoretical acid value of 22 mg KOH/g solution, an approximate Mw 14,200 and an approximate Mn 5,150 with a measured solids content of 57.8%. The solids content, as reported herein, of the polymer was determined at 110° C. for one hour according to ASTM D2369-93.

### Example 2

### Preparation of a Phosphatized Acrylic Polymer Dispersion

A phosphatized acrylic polymer dispersion was prepared using the components listed in Table 3 as follows:

TABLE 3

| | |
|---|---|
| Ingredients | Parts by weight |

Charge #1

| | |
|---|---|
| Acrylic solution from Example 1 | 3990.4 |

Charge #2

| | |
|---|---|
| Dimethylethanolamine | 124.5 |
| Deionized water | 73.3 |

Charge #3

| | |
|---|---|
| Deionized water | 3646.0 |
| BYK-011⁴ | 0.10 |

⁴A silicone-free, polymer-based defoamer, available from BYK Additives and Instruments (Wesel, Germany)

Charge #1 was added into a 5-liter, 4-necked flask equipped with a motor-driven steel stir blade, a thermocouple, a nitrogen inlet, and a water-cooled condenser. The solution was heated to ˜95° C., by a mantle controlled by the thermocouple via a temperature feedback control device. In a separate 12-liter, 4-necked flask equipped with a motor driven steel stir blade, a thermocouple, a nitrogen inlet and water cooled condenser, Charge #3 was added and heated to 60° C. by mantle controlled thermocouple via temperature feedback control device. When Charge #1 reached 95° C., Charge #2 was added dropwise over 10 minutes and the mixture was stirred for 15 minutes. After the hold, the acrylic solution in the 5-liter flask was dispersed into the aqueous solution in the 12-liter flask over 30 minutes. After the addition was complete, the resulting phosphatized acrylic polymer dispersion was cooled, and solids content was measured at 30.4% (as described in Example 1). An additional 672 g of deionized water was added to adjust the final solids content to 27.6%. The milliequivalents (meq) of acid on the final dispersion was measured as 0.187 and the meq of base was measured as 0.165 based on ASTM D4370. The only deviations made to ASTM D4370 were deviations of the sample weights and volume of solvent. ASTM D4370 suggests using 5 mL of sample and 40 mL of solvent. However, the meq measurement of the present application used 0.3 divided by the theory value for sample weight to determine grams of sample to use, and 70 mL of solvent were used.

### Examples 3-11

### Black Coating Compositions Prepared with Acrylic Polymer having an Mw of ˜25,000-30,000

For Examples 3-39 and 41-44, at least one of the following tests were performed on a coating formed by application and curing of a coating composition. A description of each test is provided hereinafter.

Dry Adhesion Tests (Al, Cr, Chrome-free): The prepared coating compositions were applied over three different substrate materials (a bare aluminum substrate, a Cr pretreated aluminum substrate, and an ECLPS 2100QC (non-chrome alternative) pretreated aluminum substrate, respectively) by Nordson Electrostatic Powder Spraying and cured to form a coating. The sample was allowed to cool to room temperature. Dry adhesion tests were performed on the prepared coated substrate according to AAMA 2605-13 Voluntary Specification, Performance Requirements and Test Procedures for Superior Performing Organic Coatings on Aluminum Extrusions and Panels using tape specified in ASTM D3359. The dry adhesion tests are an indication of direct to metal adhesion on the substrate over which the coating composition was applied.

Boiling Water Adhesion Tests (Al, Cr, Chrome-free): The prepared coating compositions were applied over three different substrate materials (a bare aluminum substrate, a Cr pretreated aluminum substrate, and an ECLPS 2100QC (non-chrome alternative) pretreated aluminum substrate, respectively) by Nordson Electrostatic Powder Spraying and cured to form a coating. The sample was allowed to cool to room temperature. Boiling water adhesion tests were performed on the prepared coated substrate according to AAMA 2605-13 Voluntary Specification, Performance Requirements and Test Procedures for Superior Performing Organic Coatings on Aluminum Extrusions and Panels using tape specified in ASTM D3359. The boiling water adhesion tests are an indication of long term adhesion of the direct to metal on the substrate over which coating composition was applied.

WOM Test: The coating composition was applied over an aluminum panel from ACT Test Panels LLC (Hillsdale, Mich.). The WOM Test was performed per SAE J2527 with borosilicate inner filter and borosilicate outer filter (Atlas ci65A Weather-o-meter).

QUV B Test: The coating composition was applied over an aluminum panel from ACT Test Panels LLC (Hillsdale, Mich.). The QUV B Test was performed per ISO 16474-3 with irradiance at 0.49 W/m², light cycle temp of 70° C. for 8 hours, dark cycle temp of 50° C. for 4 hours (Q-Panel Lab Products, QUV/se).

Black colored coating compositions for Comparative Examples 3 and 4 and Examples 5-11 were prepared using the components listed in Table 4 (amounts in grams). Test results for coatings formed from these coating compositions are provided in Table 5.

The coating compositions for Comparative Examples 3 and 4 and Examples 5-11 were prepared by the following protocol. The entire acrylic polymer dispersion was added to a container, the pigments and fillers were then added and mixed. The fluoropolymer, in its entirety, was then added to the acrylic mixture with agitation. The mixture was then ground until a 4.5 reading on a Hegman Gauge was achieved. The resulting mixture was then dried.

Once the mixture was dried, it was ground using an Air Classifying Mill so that the median particle size was no greater than 88 microns. It was then sprayed onto the substrate using powder electrostatic spraying. The coating composition was then cured for 25 minutes at 425° F. (218.3° C.) to form a coating.

TABLE 4

| | Comp. | Comp. | | | | | | Ex. | Ex. |
|---|---|---|---|---|---|---|---|---|---|
| Component | Ex. 3 | Ex. 4 | Ex. 5 | Ex. 6 | Ex. 7 | Ex. 8 | Ex. 9 | 10 | 11 |
| Fluoropolymer⁵ | 600 | 203 | 150 | 150 | 150 | 600 | 150 | 600 | 600 |
| Non-Phosphatized | 943 | 316 | 234 | 234 | 234 | 936 | 234 | 936 | — |
| Acrylic Polymer⁶ | | | | | | | | | |
| PAM Polymer 1⁷ | — | — | — | — | — | — | — | — | 938.4 |
| MONARCH 1300⁸ | 29.6 | 10 | 7.4 | 7.4 | 7.4 | 29.6 | 7.4 | 29.6 | 29.6 |
| (Black) | | | | | | | | | |
| MICRO MICA | — | — | — | 7 | 7 | 29.6 | 7.4 | 29.6 | 29.6 |
| W1⁹ | | | | | | | | | |
| Blocked | — | — | 14.8 | 15 | 15 | 59.2 | 14.8 | 59.2 | 59.2 |
| Isocyanate¹⁰ | | | | | | | | | |
| Barium Sulfate¹¹ | — | 35 | — | — | — | — | 14.8 | 59.2 | 59.2 |
| TINUVIN 144¹² | — | 2 | 1.5 | 1.5 | 1.5 | 6 | 1.5 | 6 | 6 |
| BYK-012¹³ | — | 3 | 2.2 | 2.2 | 2.2 | 8.8 | 2.2 | 8.8 | 8.8 |
| Anionic Clay¹⁴ | — | — | 7.4 | 3.7 | 7.4 | 29.6 | 7.4 | 29.6 | 29.6 |

⁵KYNAR 711, a powder form of polyvinylidene fluoride, available from Arkema, Inc. (Colombes, France)
⁶A non-phosphatized acrylic polymer having 27.3% solids and a Mw of 30,000, prepared from the following monomers: 74% methyl methacrylate (MMA), 22% ethyl acrylate (EA), and 4% methacrylic acid (MAA) in a water/DOWANOL PM solvent
⁷A phosphatized acrylic polymer having 27.4% solids and a Mw of 25,000, prepared from the following monomers: 80% MMA, 11.9% EA, 5% MAA, and 3.1% SIPOMER PAM 200 in a water/DOWANOL PM solvent
⁸A carbon black pigment available from Cabot Corporation (Boston, MA)
⁹A mica available from Imerys Performance Materials (Roswell, GA)
¹⁰A blocked isocyanate
¹¹BLANC FIXE, available from Solvay S. A. (Brussels, Belgium)
¹²A light stabilizer, available from BASF (Ludwigshafen, Germany)
¹³A mixture of polymers, silicone free, available from BYK Additives and Instruments (Wesel, Germany)
¹⁴A hydrotalcite-like material

TABLE 5

| | Comp. | Comp. | | | | | | Ex. | Ex. |
|---|---|---|---|---|---|---|---|---|---|
| Test | Ex. 3 | Ex. 4 | Ex. 5 | Ex. 6 | Ex. 7 | Ex. 8 | Ex. 9 | 10 | 11 |
| Al Adhesion | 5 | 0 | — | — | — | 5 | — | 5 | 5 |
| Al Boiling Water | 0 | 0 | 2 | 5 | 5 | 5 | 5 | 4 | 5 |
| Cr Adhesion | 5 | 0 | — | — | — | 5 | — | 5 | 5 |
| Cr Boiling Water | 0 | 0 | 5 | 5 | 5 | 5 | 5 | 5 | 5 |
| Chrome-free | — | — | — | — | — | 5 | — | 5 | 5 |
| Pretreatment Adhesion | | | | | | | | | |
| Chrome-free | — | — | — | 4+ | 5 | 5 | — | 5 | 5 |
| Pretreatment Boiling | | | | | | | | | |
| Water | | | | | | | | | |
| QUV B, 6500 h (% | — | — | — | — | — | 30 | — | 30 | 66 |
| gloss retention) | | | | | | | | | |
| WOM, 5500 h (% | — | — | — | — | — | 44 | — | 38 | 68 |
| gloss retention) | | | | | | | | | |

### Examples 12-20

### Black Coating Compositions Prepared with Phosphatized Acrylic Polymer having an Mw of ˜20,000

Black colored coating compositions for Examples 12-20 were prepared using the components listed in Table 6 (amounts in grams). Test results for coatings formed from these coating compositions are provided in Table 7.

The coating compositions for Examples 12-20 were prepared as described in Comparative Examples 3 and 4 and Examples 5-11.

TABLE 6

| | Ex. | Ex. | Ex. | Ex. | Ex. | Ex. | Ex. | Ex. | Ex. |
|---|---|---|---|---|---|---|---|---|---|
| Component | 12 | 13 | 14 | 15 | 16 | 17 | 18 | 19 | 20 |
| Fluoropolymer⁵ | 203 | 150 | 150 | 150 | 150 | 150 | 150 | 150 | 150 |
| PAM Polymer 2¹⁵ | 303 | 224 | 224 | 224 | 224 | 224 | 226 | 224 | 224 |
| MONARCH 1300⁸ | 10 | 7.4 | 7.4 | 7.4 | 7.4 | 7.4 | 7.4 | 7.4 | 7.4 |
| (Black) | | | | | | | | | |
| MICRO MICA | 10 | 7.4 | 7.4 | 7.4 | 7.4 | 7.4 | — | 7.4 | — |
| W1⁹ | | | | | | | | | |
| Blocked | 20 | 14.8 | 14.8 | 14.8 | 14.8 | 14.8 | 14.8 | 14.8 | 14.8 |
| Isocyanate¹⁰ | | | | | | | | | |
| Barium Sulfate¹¹ | 20 | 14.8 | 14.8 | 14.8 | 14.8 | 14.8 | 14.8 | 14.8 | — |
| TINUVIN 144¹² | 2 | 1.5 | 1.5 | 1.5 | 1.5 | 1.5 | 1.5 | 1.5 | 1.5 |
| BYK-012¹³ | 3 | 2.2 | 2.2 | 2.2 | 2.2 | 2.2 | 2.2 | 2.2 | 2.2 |
| 1,6 hexanediamine | — | 13.3 | 13.3 | — | — | — | — | — | — |
| hexanoic acid¹⁶ | | | | | | | | | |
| Anionic Clay¹⁴ | — | — | — | — | — | — | 1.1 | 7.4 | 7.4 |
| NUBIROX 106¹⁷ | — | 7.4 | — | — | — | — | — | — | — |
| Zn Phosphate¹⁸ | — | — | 7.4 | — | — | — | — | — | — |
| Zn Flake¹⁹ | — | — | — | 7.4 | — | — | — | — | — |
| Corrosion | — | — | — | — | 7.4 | — | — | — | — |
| Inhibitor²⁰ | | | | | | | | | |
| Antioxidant²¹ | — | — | — | — | — | 7.4 | — | — | — |

¹⁵A phosphatized acrylic polymer having approximately 29% solids and a Mw of 20,000, prepared from the following monomers: 80% MMA, 10% EA, 5% MAA, and 5% SIPOMER PAM 200 in a water/DOWANOL PM solvent
¹⁶A sag control agent
¹⁷Organophilized zinc phosphate and zinc molybdate pigment available from The Cary Company (Addison, IL)
¹⁸Zinc Phosphate ZP 10, available from Heubach GmbH (Langelsheim, Germany)
¹⁹Premium Zn Flake Z45B, available from Metal Flake Technologies LLC, (Clarksville, TN)
²⁰HALOX Z-PLEX 250 available from Advanced Additives (Hammond, Indiana)
²¹SONGSTAB SZ-210 available from Songwon Industrial Co., Ltd. (Ulsan, South Korea)

TABLE 7

| | Ex. | Ex. | Ex. | Ex. | Ex. | Ex. | Ex. | Ex. | Ex. |
|---|---|---|---|---|---|---|---|---|---|
| Test | 12 | 13 | 14 | 15 | 16 | 17 | 18 | 19 | 20 |
| Al Adhesion | 5 | — | — | — | — | — | — | — | — |
| Al Boiling | 3 | 0 | 0 | 5 | 0 | 0 | 0 | 5 | 5 |
| Water | | | | | | | | | |
| Cr Boiling | 0 | 3 | 3 | 5 | 5 | 4 | 4 | 5 | 5 |
| Water | | | | | | | | | |

### Examples 21-26

### Black Coating Compositions Prepared with Phosphatized Acrylic Polymer having an Mw of ˜15,000

Black colored coating compositions for Examples 21-26 were prepared using the components listed in Table 8 (amounts in grams). Test results for coatings formed from these coating compositions are provided in Table 9.

The coating compositions for Examples 21-26 were prepared as described in Comparative Examples 3 and 4 and Examples 5-11.

TABLE 8

| | Ex. | Ex. | Ex. | Ex. | Ex. | Ex. |
|---|---|---|---|---|---|---|
| Component | 21 | 22 | 23 | 24 | 25 | 26 |
| Fluoropolymer⁵ | 150 | 150 | 150 | 150 | 600 | 600 |
| PAM Polymer 3²² | 224 | 224 | 224 | 224 | 931.7 | 931.7 |
| MONARCH 1300⁸ | 7.4 | 7.4 | 7.4 | 7.4 | 29.6 | 29.6 |
| (Black) | | | | | | |
| MICRO MICA W1⁹ | 7 | — | 7 | 7 | 29.6 | 29.6 |
| Blocked Isocyanate¹⁰ | — | 15 | 15 | 15 | 59.2 | 59.2 |
| Barium Sulfate¹¹ | — | — | — | — | — | 59.2 |
| TINUVIN 144¹² | 1.5 | 1.5 | 1.5 | 1.5 | 6 | 6 |
| BYK-012¹³ | 2.2 | 2.2 | 2.2 | 2.2 | 8.8 | 8.8 |
| Anionic Clay¹⁴ | 7.4 | 7.4 | 3.7 | 5.54 | 29.6 | 29.6 |

²²The phosphatized acrylic polymer from Example 2 having an Mw of 14,200

TABLE 9

| | Ex. | Ex. | Ex. | Ex. | Ex. | Ex. |
|---|---|---|---|---|---|---|
| Test | 21 | 22 | 23 | 24 | 25 | 26 |
| Al Adhesion | — | — | — | — | 5 | 5 |
| Al Boiling Water | 0 | 5 | 4 | 4 | 5 | 5 |
| Cr Adhesion | — | — | — | — | 5 | 5 |
| Cr Boiling Water | 4− | 5 | 4+ | 4+ | 5 | 5 |
| Chrome-free | — | — | — | — | 5 | 5 |
| Pretreatment | | | | | | |
| Adhesion | | | | | | |
| Chrome-free | 0 | 5 | 4 | 4+ | 5 | 5 |
| Pretreatment | | | | | | |
| Boiling Water | | | | | | |
| QUV B, 6500 h (% | — | — | — | — | 65 | 63 |
| gloss retention) | | | | | | |
| WOM, 5500 h (% | — | — | — | — | 70 | 71 |
| gloss retention) | | | | | | |

### Example 27-31

### White Coating Compositions Prepared with Acrylic Polymer having an Mw of ˜25,000

White colored coating compositions for Comparative Example 27 and Examples 28-31 were prepared using the components listed in Table 10 (amounts in grams). Test results for coatings formed from these coating compositions are provided in Table 11.

The coating compositions for Comparative Example 27 and Examples 28-31 were prepared as described in Comparative Examples 3 and 4 and Examples 5-11.

TABLE 10

| | Comp. | Ex. | Ex. | Ex. | Ex. |
|---|---|---|---|---|---|
| Component | Ex. 27 | 28 | 29 | 30 | 31 |
| Fluoropolymer⁵ | 203 | 150 | 600 | 600 | 600 |
| Non-Phosphatized | 316 | 234 | 936 | 936 | — |
| Acrylic Polymer⁶ | | | | | |
| PAM Polymer 1⁷ | — | — | — | — | 938.4 |
| Titanium | 120 | 65 | 260 | 260 | 260 |
| Dioxide²³ | | | | | |
| MICRO MICA | — | 7 | 29.6 | 29.6 | 29.6 |
| W1⁹ | | | | | |
| Blocked | — | 15 | 59.2 | 59.2 | 59.2 |
| Isocyanate¹⁰ | | | | | |
| Barium Sulfate¹¹ | 35 | — | — | 59.2 | 59.2 |
| TINUVIN 144¹² | 2 | 1.5 | 6 | 6 | 6 |
| BYK-012¹³ | 3 | 2.2 | 8.8 | 8.8 | 8.8 |
| Anionic Clay¹⁴ | — | 3.7 | 29.6 | 29.6 | 29.6 |

²³TI-PURE R-960 available from DuPont (Wilmington, DE)

TABLE 11

| | Comp. | Ex. | Ex. | Ex. | Ex. |
|---|---|---|---|---|---|
| Test | Ex. 27 | 28 | 29 | 30 | 31 |
| Al Adhesion | 5 | — | 5 | 5 | 5 |
| Al Boiling Water | 0 | 5 | 5 | 5 | 5 |
| Cr Adhesion | 5 | — | 5 | 5 | 5 |
| Cr Boiling Water | 4 | 5 | 5 | 5 | 5 |
| Chrome-free | — | — | 5 | 5 | 5 |
| Pretreatment | | | | | |
| Adhesion | | | | | |
| Chrome-free | — | 4.5 | 5 | 5 | 5 |
| Pretreatment | | | | | |
| Boiling Water | | | | | |
| QUV B, 6500 h (% | — | — | 48 | 52 | 96 |
| gloss retention) | | | | | |
| WOM, 5500 h (% | — | — | 57 | 55 | 82 |
| gloss retention) | | | | | |

### Examples 32 and 33

### White Coating Compositions Prepared with Phosphatized Acrylic Polymer having an Mw of ˜15,000

White colored coating compositions for Examples 32 and 33 were prepared using the components listed in Table 12 (amounts in grams). Test results for coatings formed from these coating compositions are provided in Table 13.

The coating compositions for Examples 32 and 33 were prepared as described in Comparative Examples 3 and 4 and Examples 5-11.

TABLE 12

| | Ex. | Ex. |
|---|---|---|
| Component | 32 | 33 |
| Fluoropolymer⁵ | 600 | 600 |
| PAM Polymer 3²² | 931.7 | 931.7 |
| Titanium | 260 | 260 |
| Dioxide²³ | | |
| MICRO MICA | 29.6 | 29.6 |
| W1⁹ | | |
| Blocked | 59.2 | 59.2 |
| Isocyanate¹⁰ | | |
| Barium Sulfate¹¹ | — | 59.2 |
| TINUVIN 144¹² | 6 | 6 |
| BYK-012¹³ | 8.8 | 8.8 |
| Anionic Clay¹⁴ | 29.6 | 29.6 |

TABLE 13

| | Ex. | Ex. |
|---|---|---|
| Test | 32 | 33 |
| Al Adhesion | 5 | 5 |
| Al Boiling Water | 5 | 5 |
| Cr Adhesion | 5 | 5 |
| Cr Boiling Water | 5 | 5 |
| Chrome-free | 5 | 5 |
| Pretreatment | | |
| Adhesion | | |
| Chrome-free | 5 | 5 |
| Pretreatment | | |
| Boiling Water | | |
| QUV B, 6500 h (% | 93 | 86 |
| gloss retention) | | |
| WOM, 5500 h (% | 86 | 82 |
| gloss retention) | | |

### Examples 34-39

Unpigmented coating compositions for Comparative Example 34 and Examples 35-39 were prepared using the components listed in Table 14 (amounts in grams). Test results for coatings formed from these coating compositions are provided in Table 15.

The coating compositions for Comparative Example 34 and Examples 35-39 were prepared as described in Comparative Examples 3 and 4 and Examples 5-11.

TABLE 14

| | Comp. | Ex. | Ex. | Ex. | Ex. | Ex. |
|---|---|---|---|---|---|---|
| Component | Ex. 34 | 35 | 36 | 37 | 38 | 39 |
| Fluoropolymer⁵ | 150 | 150 | 150 | 150 | 150 | 150 |
| Non-Phosphatized | 234 | 234 | 234 | — | — | — |
| Acrylic Polymer⁶ | | | | | | |
| PAM Polymer 3²² | — | — | — | 233.2 | 233.2 | 233.2 |
| Blocked Isocyanate⁹ | — | — | 14.8 | 14.8 | — | 14.8 |
| Anionic Clay¹⁴ | — | 7.4 | 7.4 | — | 7.4 | 7.4 |

TABLE 15

| | Comp. | | | | | |
|---|---|---|---|---|---|---|
| Test | Ex. 34 | Ex. 35 | Ex. 36 | Ex. 37 | Ex. 38 | Ex. 39 |
| Al Adhesion | 5 | 5 | 5 | 5 | 5 | 5 |
| Al Boiling | 0 | 1 | 5 | 1 | 0 | 5 |
| Water | | | | | | |
| Cr Adhesion | 5 | 5 | 5 | 5 | 5 | 5 |
| Cr Boiling | 0 | 4 | 5 | 3 | 4 | 5 |
| Water | | | | | | |

### Example 40

### Preparation of a Phosphatized Acrylic Polymer

A phosphatized acrylic polymer was prepared by mixing the components in the amounts listed in Table 16.

TABLE 16

| Ingredients | Parts by weight |
|---|---|
| DOWANOL PM Acetate²⁴ | 1431.7 |
| TRIGONOX 131²⁵ | 49.7 |
| Ethyl Acrylate | 392.8 |
| Methyl Methacrylate | 1027.3 |
| PAM 200³ | 49.3 |
| Methacrylic Acid | 39.5 |
| Hydroxyethyl Acrylate | 82.4 |
| TINUVIN 123²⁶ | 16.6 |
| Dimethyl ethanolamine | 49.7 |

²⁴DOWANOL PM Acetate is propylene glycol monomethyl ether acetate, available from Dow Chemical Company (Midland, MI)
²⁵TRIGONOX 131 is tert-amyl peroxy 2-ethylhexyl carbonate, available from Akzo Nobel Chemicals (Arnhem, Netherlands)
²⁶TINUVIN 123 is a hindered amine light stabilizer. It is the reaction mass of: bis(2,2,6,6-tetramethyl-1-octyloxypiperidin-4-yl)-1,10-decanedioate; 1,8-bis[(2,2,6,6-tetramethyl-4-((2,2,6,6-tetramethyl-1-octyloxypiperidin-4-yl)-decan-1,10-dioyl)piperidin-1-yl)oxy]octane and is available from BASF (Ludwigshafen, Germany)

The final acrylic polymer solution obtained had an acid value of 13.7 mg KOH/g solution, an approximate Mw 18,700 and an approximate Mn 3,250 with a measured 110° C. solids of 51.9%.

### Examples 41-44

### Liquid Coating Compositions

Pigmented liquid coating compositions for Comparative Example 41 and Examples 42-44 were prepared using the components listed in Table 17 (amounts in grams).

The coating compositions for Comparative Example 41 and Examples 42-44 were prepared by the following protocol. Acrylic, fluoropolymer, and a portion of the solvent were added to a container and mixed and then pigment was added with mixing and dispersed until a 5 reading on a Hegman Gauge was achieved. The remainder of the ingredients were subsequently added with mixing.

TABLE 17

| | Comp. | | | |
|---|---|---|---|---|
| Component | Ex. 41 | Ex. 42 | Ex. 43 | Ex. 44 |
| Fluoropolymer²⁷ | 67.44 | — | 67.44 | — |
| Non-Phosphatized Acrylic | 52.51 | — | — | — |
| Polymer²⁸ | | | | |
| PAM Polymer 4²⁹ | — | — | 50.94 | — |
| Isophorone³⁰ | 40.9 | — | 36.63 | — |
| Pigment³¹ | 35 | — | 35 | — |
| CYMEL 303³² | 5 | — | 5 | — |
| NACURE 5414³³ | 0.5 | — | 0.5 | — |
| Flow additive | 0.67 | — | 0.67 | — |
| CYASTAT SN³⁴ | 0.20 | — | 0.20 | — |
| DOWANOL PM Acetate²⁴ | 41.8 | — | 41.14 | — |
| Composition from Example 41 | — | 107.17 | — | — |
| Composition from Example 43 | — | — | — | 106.86 |
| Anionic Clay¹⁴ | — | 0.40 | — | 0.49 |

²⁷HYLAR 5000, a powder form of polyvinylidene fluoride, available from Solvay S.A. (Brussels, Belgium)
²⁸A non-phosphatized acrylic polymer having 50.4% solids in DOWANOL PM Acetate solvent and a Mw of 15,500, prepared from the following monomers: 64.6% methyl methacrylate (MMA), 27.8% ethyl acrylate (EA), 5.2% 2-hydroxyethyl acrylate and 2.5% methacrylic acid (MAA)
²⁹Phosphatized acrylic polymer as described in Example 40
³⁰Solvent available from Dow Chemical (Midland, MI)
³¹Pigment Yellow 25 available from The Shepherd Color Company (Cincinnati, OH)
³²Hexamethoxymethyl melamine available from Allnex (Frankfurt, Germany)
³³Catalyst available from King Industries, Inc. (Norwalk, CT)
³⁴Antistatic agent commercially available from Cytec Industries, Inc. (Woodland Park, NJ)

The coating compositions from Table 17 were applied to substrates via a drawdown bar and baked at 465° F. (240.6° C.) peak metal temperature for 30 seconds to achieve a dry film thickness of 0.7-0.8 mils (17.78 μm to 20.32 μm). Test results for coatings formed from these coating compositions are provided in Table 18.

TABLE 18

| | Comp. | | | |
|---|---|---|---|---|
| Test | Ex. 41 | Ex. 42 | Ex. 43 | Ex. 44 |
| Al Adhesion | 5 | 5 | 5 | 5 |
| Al Boiling | 0 | 2 | 5 | 5 |
| Water | | | | |
| Cr Adhesion | 5 | 5 | 5 | 5 |
| Cr Boiling | 5 | 5 | 5 | 5 |
| Water | | | | |

From the above-described examples, it can be seen that inclusion of a PAM Polymer enhances UV durability of a cured coating composition, and inclusion of an adhesion promotor (optionally with a blocked isocyanate) enhances adhesion of a cured coating composition to a substrate.

The present invention further includes the subject matter of the following clauses.

Clause 1: A coating composition, comprising: a fluoropolymer; and a phosphatized acrylic polymer.

Clause 2: The coating composition of clause 1, further comprising a blocked isocyanate

Clause 3: The coating composition of clause 1 or 2, further comprising an adhesion promoter comprising: an anionic clay, a cationic clay, a chelating agent, a zinc-containing compound, a magnesium-containing compound, a manganese-containing compound, or some combination thereof.

Clause 4: The coating composition of any of the preceding claims, wherein the phosphatized acrylic polymer is prepared from a reaction mixture of at least one non-phosphatized acrylic monomer and at least one phosphatized acrylic monomer, wherein the phosphatized acrylic monomer comprises at least 0.5 weight percent % of the reaction mixture, based on the weight of the non-phosphatized acrylic monomer and the phosphatized acrylic monomer.

Clause 5: The coating composition of any of clauses 2-4, wherein the blocked isocyanate is present in an amount of up to 20 weight percent, based on total solids

Clause 6: The coating composition of any of clauses 3-5, wherein the adhesion promoter is present in an amount of up to 10 weight percent, based on total solids.

Clause 7: The coating composition of any of the preceding clauses, wherein the coating composition comprises the blocked isocyanate and the adhesion promoter.

Clause 8: The coating composition of any of the preceding clauses, wherein the phosphatized acrylic polymer has a weight average molecular weight (Mw) of less than 30,000.

Clause 9: The coating composition of any of the preceding clauses, wherein the phosphatized acrylic polymer has a weight average molecular weight (Mw) of less than 20,000.

Clause 10: The coating composition of any of clauses 2-9, wherein the coating composition comprises the blocked isocyanate, and wherein the blocked isocyanate does not react with the phosphatized acrylic polymer to crosslink the coating composition.

Clause 11: The coating composition of any of the preceding clauses, further comprising a crosslinker.

Clause 12: The coating composition of any of clauses 1-10, wherein the coating composition comprises a thermoplastic polymer.

Clause 13: The coating composition of any of the preceding clauses, further comprising mica.

Clause 14: The coating composition of any of clauses 4-13, wherein the phosphatized acrylic monomer comprises at least 1 weight percent % of the reaction mixture, based on the weight of the non-phosphatized acrylic monomer and the phosphatized acrylic monomer.

Clause 15: The coating composition of any of clauses 4-14, wherein the phosphatized acrylic monomer comprises at least 3 weight percent % of the reaction mixture, based on the weight of the non-phosphatized acrylic monomer and the phosphatized acrylic monomer.

Clause 16: The coating composition of any of clauses 4-15, wherein the phosphatized acrylic monomer comprises at least 5 weight percent % of the reaction mixture, based on the weight of the non-phosphatized acrylic monomer and the phosphatized acrylic monomer.

Clause 17: The coating composition of any of clauses 4-16, wherein the reacted amount of phosphatized acrylic monomer comprises at least 0.2 weight percent % of the coating composition, based on total solids.

Clause 18: The coating composition of any of clauses 4-17, wherein the reacted amount of phosphatized acrylic monomer comprises at least 0.5 weight percent % of the coating composition, based on total solids.

Clause 19: A substrate at least partially coated with the coating composition of any of the preceding clauses.

Clause 20: The substrate of clause 19, wherein the coating composition is applied directly to the substrate.

Clause 21: The substrate of clause 19 or 20, wherein the coating composition is the sole coating layer applied to the substrate.

Clause 22: The substrate of clause 20, wherein a primer coating layer is disposed between the coating composition and the substrate.

Clause 23: The substrate of any of clauses 20-22, wherein the substrate comprises metal.

Clause 24: A coating composition, comprising: a fluoropolymer; an acrylic polymer; and an adhesion promoter comprising: an anionic clay, a cationic clay, a chelating agent, a zinc-containing compound, a magnesium-containing compound, a manganese-containing compound, or some combination thereof.

Clause 25: The coating composition of clause 24, further comprising a blocked isocyanate, and wherein the blocked isocyanate does not react with the acrylic polymer to crosslink the coating composition.

Clause 26: The coating composition of clause 24 or 25, wherein the acrylic polymer comprises a phosphatized acrylic polymer.

Clause 27: The coating composition of any of clauses 24-26, wherein the coating composition comprises up to 10 weight percent of the adhesion promoter, based on total solids.

Clause 28: The coating composition of any of clauses 25-27, wherein the coating composition comprises up to 20 weight percent of the blocked isocyanate, based on total solids.

Clause 29: The coating composition of any of clauses 26-28, wherein the phosphatized acrylic polymer has a weight average molecular weight (Mw) of less than 30,000.

Clause 30: The coating composition of any of clauses 24-29, further comprising a crosslinker.

Clause 31: The coating composition of any of clauses 24-29, wherein the coating composition comprises a thermoplastic polymer.

Clause 32: The coating composition of any of clauses 26-31, wherein the phosphatized acrylic polymer has a weight average molecular weight (Mw) of less than 20,000.

Clause 33: The coating composition of any of clauses 26-32, wherein the phosphatized acrylic polymer is prepared from a reaction mixture of at least one non-phosphatized acrylic monomer and at least one phosphatized acrylic monomer, wherein the phosphatized acrylic monomer comprises at least 0.5 weight percent % of the reaction mixture, based on the weight of the non-phosphatized acrylic monomer and the non-phosphatized phosphatized acrylic monomer.

Clause 34: The coating composition of clause 33, wherein the phosphatized acrylic monomer comprises at least 1 weight percent % of the reaction mixture, based on the weight of the non-phosphatized acrylic monomer and the phosphatized acrylic monomer.

Clause 35: The coating composition of clause 33 or 34, wherein the phosphatized acrylic monomer comprises at least 3 weight percent % of the reaction mixture, based on the weight of the non-phosphatized acrylic monomer and the phosphatized acrylic monomer.

Clause 36: The coating composition of any of clauses 30-32, wherein the phosphatized acrylic monomer comprises at least 5 weight percent % of the reaction mixture, based on the weight of the non-phosphatized acrylic monomer and the phosphatized acrylic monomer.

Clause 37: A substrate at least partially coated with the coating composition of any of clauses 24-36.

Clause 38: The substrate of clause 37, wherein the substrate comprises metal.

Clause 39: The substrate of clause 37 or 38, wherein the coating composition is the sole coating layer applied to the substrate.

Clause 40: The substrate of any of clauses 37-39, wherein the coating composition is applied directly to the substrate.

Clause 41: The substrate of clause 37 or 38, wherein a primer coating layer is disposed between the coating composition and the substrate.

Whereas particular embodiments of this invention have been described above for purposes of illustration, it will be evident to those skilled in the art that numerous variations of the details of the present invention may be made without departing from the invention as defined in the appended claims.

The invention claimed is:

1. A coating composition, comprising:
a fluoropolymer; and
a phosphatized acrylic polymer.

2. The coating composition of claim 1, further comprising a blocked isocyanate and/or an adhesion promoter comprising: an anionic clay, a cationic clay, a chelating agent, a zinc-containing compound, a magnesium-containing compound, a manganese-containing compound, or some combination thereof.

3. The coating composition of claim 1, wherein the phosphatized acrylic polymer is prepared from a reaction mixture of at least one non-phosphatized acrylic monomer and at least one phosphatized acrylic monomer, wherein the phosphatized acrylic monomer comprises at least 0.5 weight percent % of the reaction mixture, based on the weight of the non-phosphatized acrylic monomer and the phosphatized acrylic monomer.

4. The coating composition of claim 2, wherein the coating composition comprises the blocked isocyanate and the adhesion promoter, wherein the blocked isocyanate is present in an amount of up to 20 weight percent, based on total solids; and the adhesion promoter is present in an amount of up to 10 weight percent, based on total solids.

5. The coating composition of claim 1, wherein the phosphatized acrylic polymer has a weight average molecular weight (Mw) of less than 30,000.

6. The coating composition of claim 1, wherein the phosphatized acrylic polymer has a weight average molecular weight (Mw) of less than 20,000.

7. The coating composition of claim 2, wherein the coating composition comprises the blocked isocyanate, and wherein the blocked isocyanate does not react with the phosphatized acrylic polymer to crosslink the coating composition.

8. The coating composition of claim 1, further comprising a crosslinker.

9. The coating composition of claim 1, wherein the coating composition comprises a thermoplastic polymer.

10. The coating composition of claim 1, further comprising a mica filler.

11. A substrate at least partially coated with the coating composition of claim 1.

12. A substrate at least partially coated with the coating composition of claim 4.

13. The substrate of claim 12, wherein the coating composition is applied directly to the substrate.

14. The substrate of claim 12, wherein the coating composition is the sole coating layer applied to the substrate.

15. The substrate of claim 12, wherein a primer coating layer is disposed between the coating composition and the substrate.

16. The substrate of claim 12, wherein the substrate comprises metal.

17. A coating composition, comprising:
a fluoropolymer;
an acrylic polymer; and
an adhesion promoter comprising: an anionic clay, a cationic clay, a chelating agent, a zinc-containing compound, a magnesium-containing compound, a manganese-containing compound, or some combination thereof.

18. The coating composition of claim 17, further comprising a blocked isocyanate, and wherein the blocked isocyanate does not react with the acrylic polymer to crosslink the coating composition.

19. The coating composition of claim 17, wherein the acrylic polymer comprises a phosphatized acrylic polymer.

20. The coating composition of claim 17, wherein the coating composition comprises up to 10 weight percent of the adhesion promoter, based on total solids.

21. The coating composition of claim 18, wherein the coating composition comprises up to 20 weight percent of the blocked isocyanate, based on total solids.

22. The coating composition of claim 19, wherein the phosphatized acrylic polymer has a weight average molecular weight (Mw) of less than 30,000.

23. The coating composition of claim 17, wherein the coating composition comprises a thermoplastic polymer.

24. A substrate at least partially coated with the coating composition of claim 17.

25. The substrate of claim 24, wherein the substrate comprises metal.

26. The substrate of claim 24, wherein the coating composition is the sole coating layer applied to the substrate.
